(19) United States
(12) Patent Application Publication
(10) Pub. No.: US 2025/0311703 A1
(43) Pub. Date: Oct. 9, 2025

(54) SAFETY LEASH APPARATUS

(71) Applicant: Andrew Barnhart, Atlanta, GA (US)

(72) Inventor: Andrew Barnhart, Atlanta, GA (US)

(21) Appl. No.: 19/169,257

(22) Filed: Apr. 3, 2025

Related U.S. Application Data
(60) Provisional application No. 63/573,693, filed on Apr. 3, 2024.

(51) Int. Cl. A01K 27/00

(52) U.S. Cl. CPC A01K 27/002; A01K 27/003

(57) ABSTRACT

In accordance with the present disclosure, a safety leash apparatus comprises an elongated strap or cord having a unitary leg loop section that is adjustable to fit around a front leg of a dog, in that the elongated strap or cord further has a body loop section that is fittable around a neck and shoulders of the dog. Further, the unitary leg loop section is tethered to the body loop section to prevent the unitary leg loop section from slipping down and off the front leg of the dog, such that the elongated strap or cord, having the unitary leg loop section and the body loop section, forms a single piece of the safety leash apparatus.

### CROSS-REFERENCE TO RELATED APPLICATION

This application claims priority to co-pending U.S. provisional application entitled, “Safety Leash Apparatus,” having application No. 63/573,693, filed Apr. 3, 2024, which is entirely incorporated herein by reference.

### BACKGROUND

A standard leash can be worn by a dog (or other type of animal) and be used to prevent the animal from running away, jumping on other persons or objects, prevent the animal from trespassing on someone else's property, train the animal to be obedient, comply with rules, ordinances, and laws for a particular geographic area, etc. However, the wearing of a standard leash can be unsafe for the animal when it is attached to a neck collar and the animal is pulling against the leash or an attendant is forcibly restraining the animal by pulling against the leash, which may choke the animal and/or cause pain. Thus, better alternatives to such types of leashes are needed that provide a safe form of restraint when an animal's movement requires restricting via the leash and prevent the animal from pulling against the owner. While a separate harness or a specialized collar may be used in addition to a standard leash, the additional bulk, complexities, and/or costs introduced by such accessories make their use more difficult or inconvenient for the animal and/or the animal's attendant/owner. Thus, it would be more beneficial to have a single apparatus that can achieve these objectives. Further, traditional harnesses or neck collars do not discourage an animal from pulling against the owner as the animal generally does not mind resistance against the larger/stronger parts of the body where these devices are worn.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows an exemplary safety leash apparatus in accordance with various embodiments of the present disclosure.

FIG. 2 shows an exemplary embodiment of the safety leash apparatus of FIG. 1 being worn by a dog.

FIG. 3 shows construction of an exemplary embodiment of the safety leash apparatus in accordance with various embodiments of the present disclosure.

FIG. 4 shows an alternative embodiment of a safety leash apparatus in accordance with the present disclosure.

### DETAILED DESCRIPTION

The present disclosure describes various embodiments of a safety leash apparatus, such as for a dog or other pet/animal. Accordingly, in various embodiments, the safety leash apparatus can be used to guide or walk a dog while also safely restraining the dog if the animal attempts to pull away from a human attendant that is holding a handle or end of the safety leash apparatus.

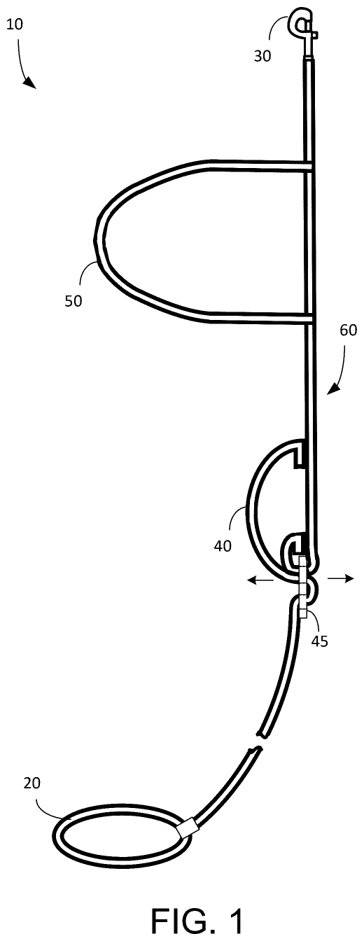

Referring now to FIG. 1, an exemplary safety leash apparatus 10 is shown. In various embodiments, the leash apparatus 10 features a loop (“hand loop”) or leash handle 20 (at one end) that can be grasped or held by a human attendant's hand, where the opposing end of the leash apparatus 10 features a clip connector 30 that can be attached to a dog collar. In various embodiments, the dog handle 20 can be, but is not limited to being, a braided end of the leash, wrapped with a tape, rubber, plastic, or other coating to form a handle, etc. In various embodiments, the clip connector 30 may be a swivel snap connector (as shown in FIG. 1), a spring snap connector, a hook and loop connector, or other type of connector apparatus that can connect to a dog collar (e.g., via a connector ring on the collar). In various embodiments, a length of the leash apparatus 10 can vary to accommodate different uses or types of animals or preferences of the human attendant, but a length of approximately six feet is used in various embodiments. In various embodiments, a material of the leash apparatus is generally leather, plastic (e.g., nylon), or cloth (e.g., cotton rope, canvas strap, etc.) in the form of an elongated strap or cord. Accordingly, in various embodiments, certain materials may be better suited for large animals/dogs versus smaller animals/dogs.

Referring back to FIG. 1, the exemplary safety leash apparatus 10 is comprised of a unitary leg loop section 40 and a body loop section 50. Accordingly, when in use, the leash apparatus is coupled to the body of a dog (or other animal) at three places. First, the clip connector 30 is attached to a neck collar worn by the dog. Second, the body loop section is worn around or between the chest/shoulders of the dog, and third, the unitary leg loop section is wrapped around a front leg of the dog (or other animal), where a length of the unitary leg loop section can be changed by configuring a slide adjuster mechanism 45 (e.g., a triglide slide having two hole openings) that can adjust a length of the unitary leg loop section 40 of the safety leash apparatus 10 by pulling or pushing the material of the leash apparatus through the openings of slide adjuster mechanism 45 (as denoted by the left and right arrows in FIG. 1). In the same manner, when the safety leash apparatus 10 is worn by the dog (or other animal), the action of the dog pulling against the leash, when held by the dog's attendant, will cause the unitary leg loop section 40 to tighten and wrap around the dog's front leg, causing the dog slight discomfort to losing leverage/stability and resulting in the dog to stop pulling away against the leash being held by the dog's attendant.

Conversely, if the dog is not pulling against the leash apparatus 10, the length of the unitary leg loop section may be maintained as being loosely fitted around the dog's front leg, which will not cause any discomfort or awkwardness. To avoid the unitary leg loop section from falling down or off the dog's front leg, the body loop section 50 is provided to fit around the dog's neck and settle around the dog's shoulders. Thus, the portion 60 (“tethering portion”) of the leash apparatus between the unitary leg loop section 40 and the body loop section 50 is of an appropriate length to prevent the unitary leg loop section 40 from slipping off the dog's front leg when the unitary leg loop section 40 is wrapped around or encircling the dog's front leg and the body loop section 50 is fitted around the dog's neck and shoulders. Since a dog's leg is tapered from its armpit down to its paw, this physiological structure, paired with gravity, means any loop strap will slide downward on the dog. To counteract this, the addition of the body loop section 50 that goes over the dog's head keeps the body loop section 50 up on the dogs body and does not permit the unitary leg loop section (leg loop) 40 to fall off the dog due to the short tethering of the unitary leg loop section 40 to the body loop section 50 via the tethering portion 60.

Accordingly, if the dog bends its head down (e.g., to sniff the ground, to drink water, etc.), the unitary leg loop section 40 will not slide down the dog's leg due to unitary leg loop section 40 being tethered or coupled to the body loop section 50. For different size dogs (or other types of animals), a variety of sizing options of leash apparatuses 10 may be provided, such as extra small, small, medium, large, extra-large, etc. options. By the first shoulder loop 40 being tethered to the second shoulder loop 50 that is fitted around a dog's shoulders as opposed to the dog's neck, a risk of the dog being choked (due to the restriction of airflow when the dog is pulling against the leash being held by the attendant) is eliminated, which provides a gentle form of restraint for the dog's movement. Further, in the embodiment shown by FIG. 1, the safety leash apparatus 10 is a unitary or single piece in that the unitary leg loop section 40 and body loop section 50 and a clip connector 30 are integrated together with the leash strap/cord being held by the dog's attendant.

Also, by attaching the leash apparatus 10 to only a single front leg instead of multiple legs, the dog (or other animal) is at less of a risk of tripping or falling down or otherwise injuring itself when pulling against the leash apparatus being held by the attendant. In this way, the dog (or other animal) will not become conditioned to being afraid of the safety leash apparatus 10 after repeated uses. Preferably, both the attendant and the dog (or other animal) should both benefit from its use. Accordingly, the safety leash apparatus 10 of the present enables for the training of a dog to walk next to their attendant on a leash without pulling during that training period. In various embodiments, the leash apparatus 10 can be used as a conventional leash or it can be put over the dogs' head and one of his legs to use as a teaching aid and as a restrictive device. Such a leash allows an attendant or owner to restrict their dog's forward pulling by using the leash to control the dogs front leg. When the dog's front leg is controlled, the dog cannot pull forward. This action is possible because the dog's leg is much easier to control than trying to control the entire dog (by their collar in the standard way) when the dog moves forward using all of its legs.

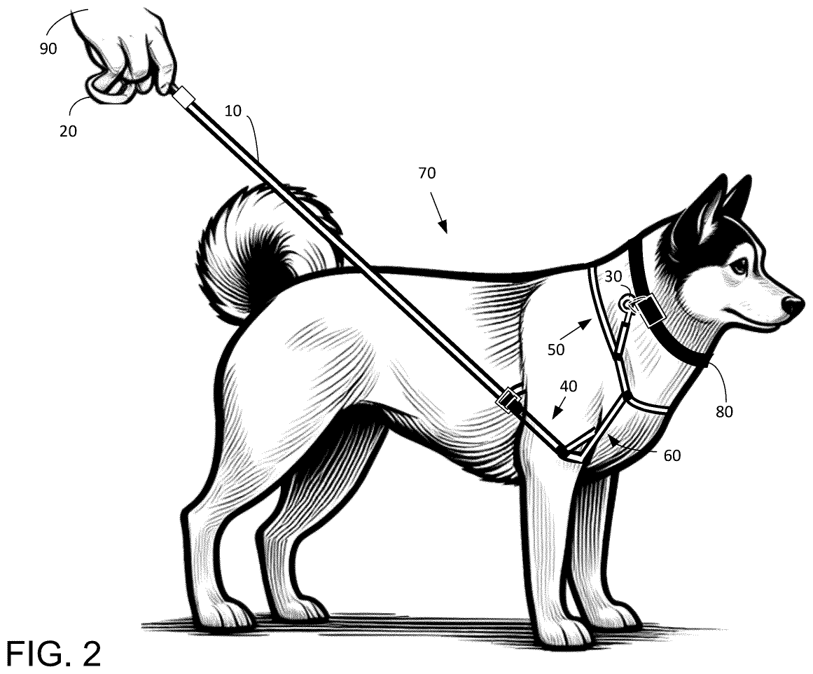

Referring now to FIG. 2, an exemplary embodiment of the safety leash apparatus 10 is shown being worn by a dog 70. As depicted, the safety leash apparatus 10 optionally connects to a dog's collar 80 via the connector clip 30. Additionally, instead of the leash apparatus 10 extending from the dog's collar 80 directly to the dog owner/attendant's hand 90, as a typical leash does, this design has a unitary leg loop section 40 integrated into the leash 10 that encircles the dogs front leg (e.g., on the side of the dog nearest the attendant) and then extends from the leg to the attendant's hand 90, which is holding onto the leash apparatus 10.

This unique design enables the attendant to restrict the dog's forward movement. For example, when the dog 70 tries to pull, the safety leash apparatus 10 functions will act to lift the looped/strapped leg (in the leg loop 40) off the ground. This action makes the dog (a) uncomfortable-but not in pain (e.g., the dog may become frustrated at having its mobility limited) and (b) it limits the strength or stability of the dog by lifting the dog's leg off the ground. By fitting the leg loop 40 around the dog's front leg, when the dog is pulling against the leash apparatus 10, the leg loop 40 will tighten and raise the dog's foot or paw off the ground and the dog will immediately lose their leverage, which most or many dogs do not like. In contrast, some dogs, when they are pulling against a standard leash that is attached to the dog's collar or a separate harness, are not bothered by the pulling action of the leash against their neck or torso, unless a chocking or pinching type of collar is used in place of the standard leash which causes pain. However, they will be bothered by becoming unsteady or unbalanced by having their front leg's range of motion restricted via the safety leash apparatus 10. Thus, unlike traditional harnesses or neck collars that are worn on the larger/stronger parts (neck and/or shoulders/chest) of an animal's body, the safety leash apparatus 10 is designed to be worn at a weak point of an animal's body-a single leg.

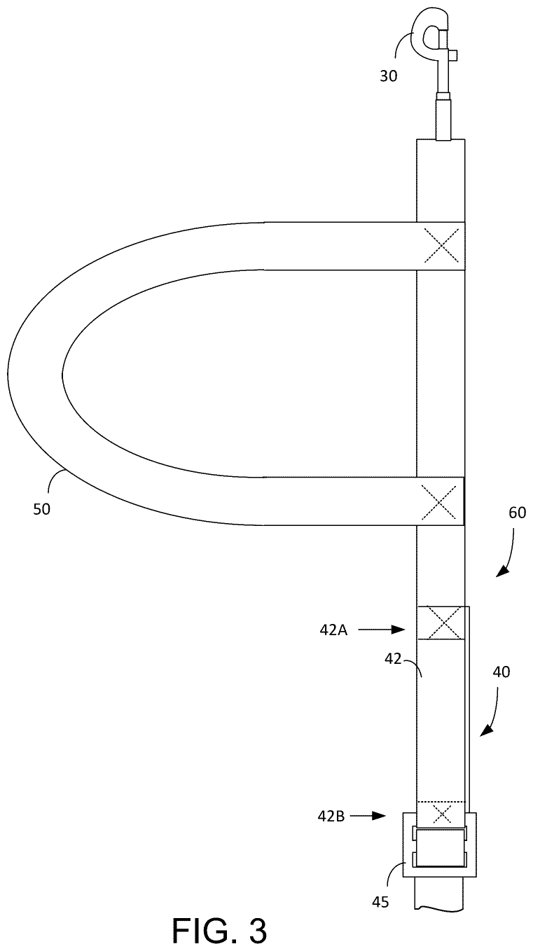

In various embodiments, the unitary leg loop section 40 can be constructed to fit around a dog (or other animal's front leg) by integrating an extra piece of material 42 (which is the same type of material as the rest of the safety leash apparatus) onto the leash apparatus 10. In various embodiments, as depicted in FIG. 1 and FIG. 3, one end 42A of the extra piece of material 42 is stitched onto the tether portion 60 of the leash apparatus 10 with the portion of the leash apparatus material that extends to the handle 20 (as shown by arrow 42A). The other end of the extra piece 42 is stitched to a slide adjuster mechanism 45 (as shown by arrow 42B). Accordingly, the unitary leg loop section 40 is formed from this piece of material 42 in combination with the material from the safety leash apparatus 10 that extends from the stitching at 42A to the leash handle 20, through the slide adjuster mechanism 45, to the handle 20. As such, in various embodiments, a portion of the safety leash apparatus feeds through the openings of the slide adjuster mechanism 45 which allows the slide adjuster mechanism to slide up and down and tighten or loosen the unitary leg loop section 40 of the leash apparatus, thereby creating as large of an opening for the unitary leg loop section 40 as is necessary to encircle the dog's front leg.

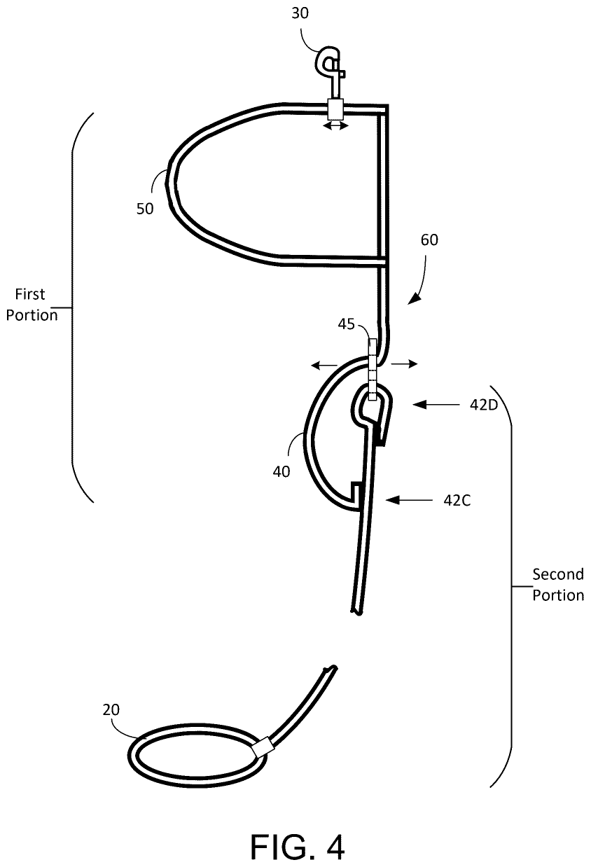

When considering the unitary leg loop section or leg loop, it can be integrated to the leash apparatus in a variety of orientations. For example, in FIG. 1 and FIG. 3, the slide adjuster mechanism 45 is positioned at a far or distal end of the unitary leg loop section that is closer to the handle 20 (as opposed to the stitching 42A). In an alternative embodiment, as shown in FIG. 4, the slide adjuster mechanism 45 is positioned at a proximal end of the unitary leg loop section 40 that is closer to the stitching 42A (as opposed to the handle). In this arrangement, the location of the slide adjuster mechanism 45 and the stitch 42A that creates the opposite side of the unitary leg loop section (leg loop) is switched. In this switched orientation, the leg loop 40 will tighten as the attendant (holding the leash handle 20) pulls on the leash due to the slide adjuster mechanism 45 being further away from the attendant in this opposite orientation and being pulled towards the attendant. As shown in the figure, the unitary leg loop section 40 can be constructed by integrating a first portion of the leash apparatus 10 (composed of the body loop section 50) with a second portion of the leash apparatus 10 (composed of the unitary leg loop section 40 and the material extending to the leash handle 20), where an end of the first portion is fed through one opening of the slide adjuster mechanism 45 and is stitched or fastened to a middle part of the second portion of the leash apparatus 10 (as shown by arrow 42C). Correspondingly, and end of the second portion is fed through the other opening of the slide adjuster mechanism 45 and is stitched to itself (as shown by arrow 42D). A length of the unitary leg loop section 40 can be adjusted by pulling or pushing the material of the leash apparatus through the slide adjuster mechanism 45 (as denoted by the left and right arrows in FIG. 4)

In various embodiments, the clip connector 30 can be coupled directly to the body strap section 50, as shown in FIG. 4, where the clip connector 30 may be configured to slide along the body strap section 50 (as depicted by the left and right arrows in FIG. 4). In alternative embodiments, the clip connector 30 may be stitched or fastened to an end of the elongated strap material of the safety leash apparatus 10, as shown in FIG. 1.

It should be emphasized that the above-described embodiments are merely possible examples of implementations, merely set forth for a clear understanding of the principles of the present disclosure. Many variations and modifications may be made to the above-described embodiment(s) without departing substantially from the principles of the present disclosure.

For example, in various alternative embodiments, the safety leash apparatus 10 can feature a unitary leg loop section 40 and a body loop section 50, where the length of the unitary leg loop section is fixed and there is no slide adjuster mechanism, such that the length of the unitary leg loop section is not adjustable. In such embodiments, the unitary leg loop section may be formed of an elastic material. Further, in various embodiments, the body loop section 50 may have a buckle fastener that allows for the body loop section 50 to be unfastened into two parts, wrapped around a dog's body, and then refastened to form a loop that wraps around the dog's body. All such modifications and variations are intended to be included herein within the scope of this disclosure.

Therefore, at least the following is claimed:

1. A safety leash apparatus comprising:
an elongated strap or cord having a unitary leg loop section that is adjustable to fit around a front leg of a dog, the elongated strap or cord further having a body loop section that is fittable around a neck and shoulders of the dog, wherein the unitary leg loop section is tethered to the body loop section to prevent the unitary leg loop section from slipping down and off the front leg of the dog,
wherein the elongated strap or cord having the unitary leg loop section and the body loop section forms a single piece of the safety leash apparatus.

2. The safety dog leash apparatus of claim 1, further comprising a clip connector that is attached to one end of the elongated strap or cord.

3. The safety leash apparatus of claim 2, further comprising a leash handle that is attached to an opposing end of the elongated strap or cord.

4. The safety leash apparatus of claim 3, wherein the leash handle comprises a hand loop.

5. The safety leash apparatus of claim 1, wherein the unitary leg loop section is adjustable via a slide adjuster mechanism to which a portion of the elongated strap or cord feeds through, wherein a pulling force of the dog against the elongated strap or cord causes the unitary leg loop section to tighten around the front leg of the dog.
